(19) United States
(12) Patent Application Publication
(10) Pub. No.: US 2024/0409067 A1
(43) Pub. Date: Dec. 12, 2024

(54) SPHERE BRAKING SYSTEM WITH SLIDE-IN BRAKE PADS

(71) Applicant: LEWIS DESIGNS, LLC, Waterford, PA (US)

(72) Inventors: Joseph FIORE, Bemus Pointe, NY (US); Aaron J. LEWIS, Union City, PA (US); Jason E. PINTEA, Erie, PA (US)

(21) Appl. No.: 18/700,321

(22) PCT Filed: Oct. 11, 2022
(86) PCT No.: PCT/US2022/046274

§ 371 Date: Apr. 11, 2024

Related U.S. Application Data
(60) Provisional application No. 63/254,407, filed on Oct. 11, 2021.

(51) Int. Cl. B60T 1/06; F16D 49/00; F16D 65/095

(52) U.S. Cl. CPC B60T 1/062; F16D 65/095; F16D 49/00

(57) ABSTRACT

A sphere brake system including a bracket (110) secured to a non-rotating component, a brake pad assembly (140) disposed externally to a spherical rotor (90), and an actuator (120) engagable with the brake pad assembly (140) to apply a force against the surface of the spherical rotor (90), where an axial face (114) of the bracket (110) includes an access window (130) located radially between the actuator (120) and the spherical rotor (90) and shaped to enable the brake pad assembly (140) to be inserted and removed, and where the brake pad assembly includes a friction pad (141), a backing plate (142), a spacer (150), and a retaining mechanism (160) that is securable to the bracket (110) or axially engageable against the actuator (120) to prevent axial movement relative to the actuator (120). Also, a corresponding sphere brake system brake pad assembly (140) for use with the sphere brake system.

This application claims priority to U.S. Provisional Patent Application Ser. No. 63/254,407, filed on Oct. 11, 2021, the entire contents of which are hereby incorporated by reference.

### BACKGROUND

Sphere brake systems represent a marked improvement over traditional disk and drum brake systems. They are generally smaller in dimension but provide significantly better braking performance and lower maintenance requirements than standard disc and drum brakes. Sphere brake systems are generally mounted to the drive shafts or axles of vehicles, and are generally composed of a spherical rotor securely attached to a rotating member such as an axle or drive shaft. External to the spherical rotor is one or more brake surfaces or brake pads that can be depressed inward to provide braking force to halt the rotation of the spherical rotor and the attached rotating member. By mounting brake surface(s) or pad(s) external to a spherical rotor, access can be greatly improved. This can be a great advantage over other braking systems when mounting a new brake surface or pad, changing a worn brake surface or pad, or performing general maintenance of the braking mechanism. However, in order to conserve space and create compact vehicle designs, sphere brake assemblies, just like other brake assemblies, may be placed within confined spaces such as the central region of a wheel rim or a drive shaft tunnel, and bounded by surrounding structure so as not to be easily accessed and serviced.

### SUMMARY

The present disclosure concerns a sphere brake system that provides improved access to the most frequently serviced components of such a system, the brake surfaces or pads and operating ends of their associated actuating mechanisms, without requiring access to the radially outer sides or outboard side (wheel attachment side) of the brake system. This improved access may also eliminate the need to remove wheels and other peripheral components during brake component maintenance. Eliminating the removal of wheels and other peripheral components will reduce time, cost, and danger associated with wheel and peripheral component removal.

First, a sphere brake system for a vehicle includes a bracket (110) secured to a non-rotating component of the vehicle to at least partially encircle a spherical rotor (90) attached to a rotating member of the vehicle, a brake pad assembly (140) disposed externally to the spherical rotor (90) and engageable with the spherical rotor (90), and an actuator (120) engageable with the brake pad assembly (140) to apply a radially inward force, normal to the surface of the spherical rotor (90). An axial face (114) of the bracket (110) includes an access window (130) located radially in the axial face (114) between the actuator (120) and the spherical rotor (90) and shaped to enable the brake pad assembly (140) to be inserted and removed from the bracket (110) through the axial face (114). The brake pad assembly (140) includes a friction pad (141), a backing plate (142), a spacer (150), and a retaining mechanism (160) that is securable to the bracket (110) or axially engageable against the actuator to prevent axial movement relative to the actuator (120).

Second, a sphere brake system brake pad assembly for use with a sphere brake system includes a friction pad (141) configured to engage a spherical rotor (90) attached to a rotating member of a vehicle, a backing plate (142), a spacer (150), and a retaining mechanism (160) configured to secure the brake pad assembly (140) to a bracket (110) secured to a non-rotating component of the vehicle or to engage against an actuator (120) to prevent lateral movement relative to the actuator (120).

### BRIEF DESCRIPTION OF THE DRAWINGS

FIG. 1 is a perspective view of a representative sphere brake system including a first exemplary embodiment of a brake pad assembly.

FIG. 2 is a cross-sectional side view of the representative sphere brake system and first exemplary embodiment shown in FIG. 1.

FIG. 3 is an exploded perspective view of the first exemplary embodiment.

FIGS. 4 and 5 are perspective views of an assembled (top item) and exploded (middle and bottom items) second exemplary embodiment of a brake pad assembly.

FIG. 6 is a perspective view of another retaining mechanism useable with the brake pad assemblies.

FIG. 7 is a perspective view of another retaining mechanism useable with the brake pad assemblies.

FIG. 8 is a perspective view of a third exemplary embodiment of a brake pad assembly.

FIG. 9 is a perspective view of a fourth exemplary embodiment of a brake pad assembly.

FIG. 10 is a side view of a fifth exemplary embodiment of a brake pad assembly.

FIG. 11 is a perspective view of the fifth exemplary embodiment in a disassembled state.

FIG. 12 is a cross-sectional side view of another retaining mechanism useable with the brake pad assemblies.

FIG. 13 is a perspective view of a sixth exemplary embodiment of a brake pad assembly.

FIG. 14 is a perspective view of the sixth exemplary embodiment in a disassembled state.

FIGS. 15 and 16 are perspective views of spacer mechanisms combinable with the brake pad assemblies.

FIG. 17 is a perspective view of a seventh exemplary embodiment in a disassembled state

FIGS. 18-20 are photographs of an implementation of the sphere brake assembly of FIGS. 1-4.

### BRIEF DESCRIPTION OF THE DRAWINGS

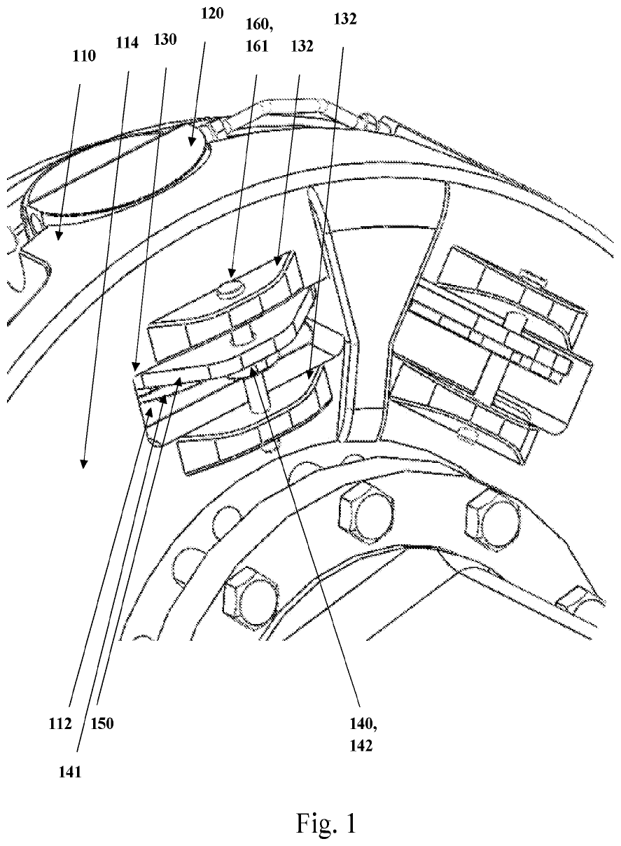

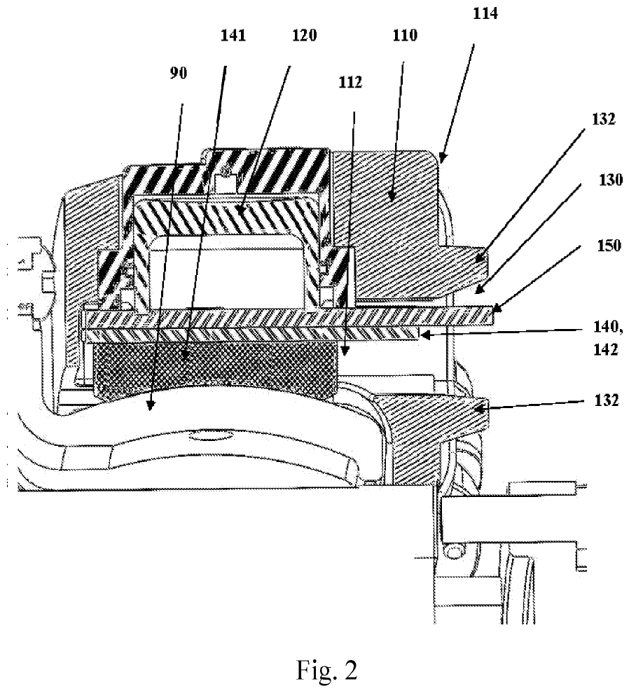

Referring initially to FIGS. 1 and 2, the present sphere brake system includes a bracket or flange 110 (hereafter, bracket 110) that is secured to a stationary (non-rotating) component of a vehicle to at least partially encircle the rotating member and spherical rotor 90, where the longitudinal axis of rotating member and orientations parallel to that axis are referred to as axial directions and orientations, and radial and angular directions and orientations are described relative to such axial directions and orientations in the manner of a cylindrical coordinate system. The stationary component may be, for example, an axle spindle, a drive shaft carrier for a drive shaft, or a special purpose mount provided in proximity to the rotating member. The bracket is configured to receive and guide a brake pad assembly 140, which may travel along the bracket or within an internal cavity 112 of the bracket, into engagement with the spherical rotor 90. The bracket is further configured to receive or mount an actuator 120 radially outward of the spherical rotor 90 and brake pad assembly 140, where the actuator 120 is engageable with the brake pad assembly 140 to apply a radially inward force, normal to the surface of the spherical rotor. The actuator 120 may be a linear actuator such as a hydraulically, pneumatically, electromagnetically, or electromechanically driven piston, or a rotary actuator such as a hydraulically, pneumatically, electromagnetically, or electromechanically driven accessory motor, and may either directly engage the brake pad assembly 140 itself, for example in the case of a piston, or indirectly engage the brake pad assembly 140 through a mechanical linkage, such as in the case of an accessory motor operating a lever arm. For sake of simplicity, the description will refer to an exemplary piston actuator 120, but it will be appreciated that other types of actuators and actuator-associated mechanisms may be substituted for the piston without departing from the principles of operation of the disclosed system.

An axial face 114 of the bracket 110 includes an access window or port 130 (hereafter, access window 130 or, simply, window 130) through the axial face. In some constructions, the access window 130 may provide access into an internal cavity 112 of the bracket 110. In other constructions, the access window 130 may provide access into a substantially enclosed space such as one defined between the bracket 110 and other vehicle structure, such as the internal surfaces of a wheel rim or surfaces of a drive shaft tunnel and/or drive shaft carrier. The access window 130 is located radially in the axial face 114 between the actuator 120 and the spherical rotor 90 and shaped to enable the brake pad assembly 140 to be inserted and removed from the bracket 110 through the axial face 114. The access window 130 may or may not include torque take-out surfaces to transfer torque generated during braking operation from the brake pad assembly 140 to the bracket 110. There may additionally or alternately be various attachment features within or proximate to the access window 130 for cooperating with a retaining mechanism to secure the brake pad assembly 140 within the bracket 110. Where the system is mounted to an axle, the access window 130 is preferably provided on an inboard axial face of the bracket 110, so that the brake pad assembly 140 may be inserted and removed without need to dismount a wheel from the axle and, more specifically, the wheel end.

The brake pad assembly 140 may take on various shapes, including generally round, square, or rectangular, as well as have various arcuate, flat, or non-flat profiles, and may be composed of multiple components including but not limited to a friction pad 141 and backing plate 142, a spacer 150, and a retaining mechanism 160. FIGS. 1 and 2 show a first embodiment of a system and brake pad assembly in which a pair of radially separated dogs 132 are provided on the axial face 114 proximate the access window 130, and each of the dogs 132, backing plate 142, and removeable spacer 150 include at least one radial aperture. In such a case, the retaining mechanism 160 may include a retaining pin 161 which engages with the respective structures 132, 142, and 150 through the radial apertures. The backing plate 142 (and associated friction pad 141) and removable spacer 150 may slide radially along the retaining pin 161 during actuation of the sphere brake system, but are retained within the bracket 110 during operation. When the brake pad assembly 140 is to be removed, the retaining pin 161 can be removed from engagement with the radial apertures, principally freeing the assembly 140 for removal. The proximal ends of the backing plate 142 and/or removable spacer 150 may be manipulated radially outward to depress the actuator 120 radially outward and thus create additional space to ease removal of the brake pad assembly 140.

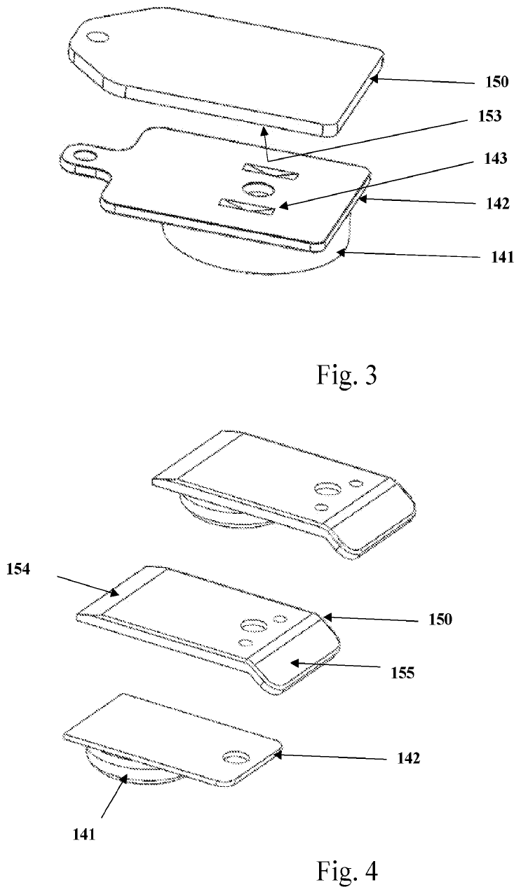

FIG. 3 shows an exploded view of a first exemplary brake pad assembly 140 shown in FIGS. 1-2. The backing plate 142 may include one or more recesses or apertures 143 which may each receive a projection 153 (not visible in these figures) provided in a corresponding location on the removable spacer 150 to interlock the brake pad assembly 140 with respect to relative sliding motion. By pulling upon the interlocked brake pad assembly 140, potentially the entire assembly can be removed as a unit through the access window 130. However, by manipulating only the removable spacer 150 radially outward, the actuator 120 may be depressed radially outward, the projection(s) 153 of the spacer 150 separated from the recess(es) 143 of the backing plate 142, and the removable spacer 150 pulled out separately from the friction pad 141 and backing plate 142 through the access window 130, whereupon the latter 141, 142 may be subsequently pulled out through the window.

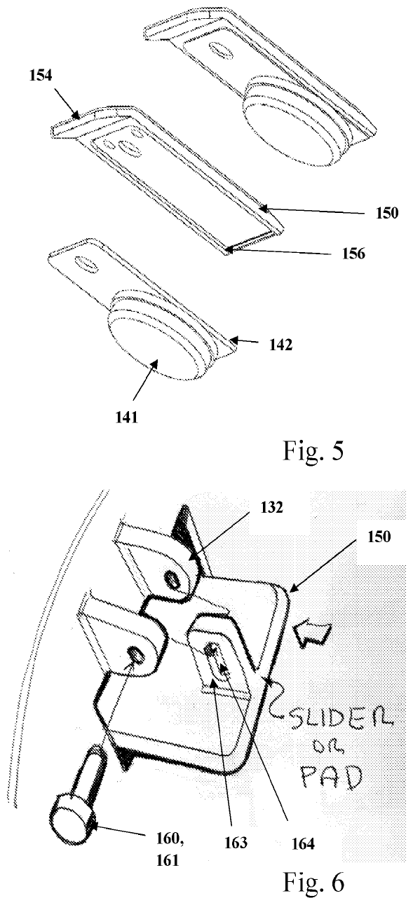

FIGS. 4 and 5 show assembled (top item) and exploded (middle and bottom item) views of a second exemplary brake pad assembly 140. A spacer 150 may include a beveled distal end 154 to aid in insertion past the actuator 120, and may alternately or also include an angled or contoured proximal tongue 155 to provide additional leverage or grip for pulling upon and manipulating the interlocked assembly for removal as a unit through the access window 130. The spacer 150 may be a removable spacer or may include C-channels 156 which engage the sides of the backing plate 142 to assist in forming the brake pad assembly 140. It will be appreciated that the assembly of FIGS. 4 and 5 may include the recess(es) 143 and projection(s) 153 of the embodiment shown in FIG. 3 to further interlock the assembly with respect to relative sliding motion, although if C-channels 156 are present each projection 153 should be configured to function more similarly to resilient detents to allow for separation of the backing plate 142 and spacer 150 along the C-channels 156 after removal from the sphere brake system.

FIG. 6 shows an alternate arrangement of the retaining mechanism useable with the aforementioned and other exemplary brake pad assemblies 140. A pair of dogs 132 may be provided on the axial face 114 proximate the access window 130, however the dogs may be angularly separated (with respect to rotation of the spherical rotor 90 and the angular coverage of the bracket 110) and may each include generally angularly oriented apertures. The removeable spacer 150 may correspondingly include a radial projection 163 and an angularly oriented, radially elongated aperture 164 (a so-called “racetrack” aperture). In such a case, the retaining mechanism 160 may include a retaining pin 161 which engages with the racetrack aperture 164 of the radial projection 163 and the angularly oriented apertures of the dogs 132. The brake pad assembly 140 may slide radially across the retaining pin 161 during actuation of the sphere brake system, but is retained within the bracket 110 during operation. When the brake pad assembly 140 is to be removed, the retaining pin 161 can be removed from engagement with the angularly oriented apertures, principally freeing the assembly 140 for removal as otherwise described herein.

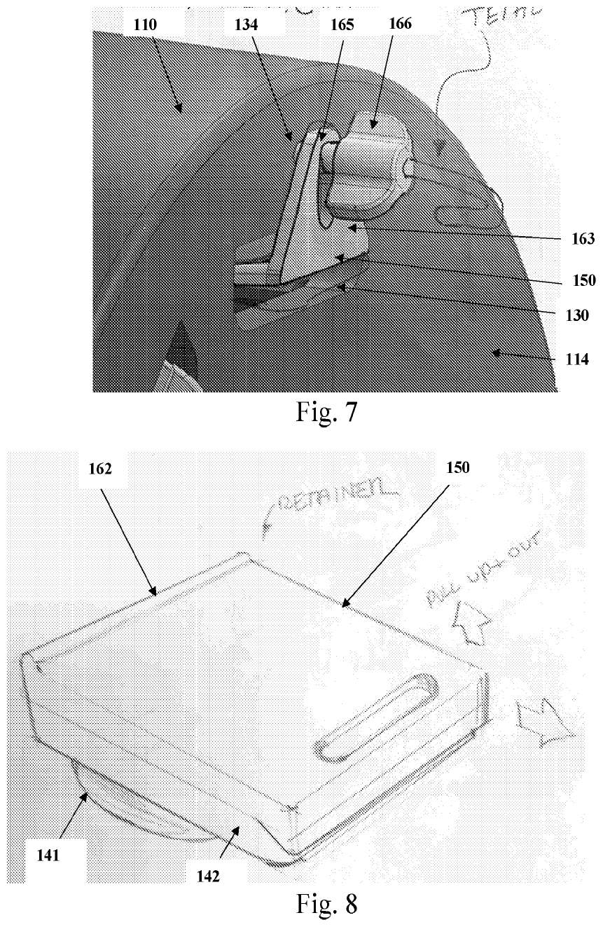

FIG. 7 shows another alternate arrangement of the retaining mechanism useable with the aforementioned and other exemplary brake pad assemblies 140. An axially oriented bracket aperture 134, which may be a threaded aperture, may be disposed in the axial face 114 outward of the access window 130. The removeable spacer 150 may correspondingly include a projection 163 and an axially oriented, radially elongated aperture 165 (or racetrack aperture). In such a case, the retaining mechanism 160 may include a retaining fastener 166 which is secured through the racetrack aperture 165 of the radial projection 163 and within the aperture 134 of the axial face 114. The retaining fastener 166 may be a thumbscrew, screw; bolt, keyed fastener, or other removable fastener. The brake pad assembly 140 may slide radially across the retaining fastener 166 during actuation of the sphere brake system, but is retained within the bracket 110 during operation. When the brake pad assembly 140 is to be removed, the retaining fastener 166 can be removed from engagement with the bracket aperture 134, principally freeing the assembly 140 for removal as otherwise described herein.

FIG. 8 shows a view of a third exemplary brake pad assembly 140. The distal end of a spacer 150 may include retaining mechanism comprising an outward oriented projection or ridge 162 for engagement against or interference against a distal edge of the actuator 120. After installation, with the spacer 150 substantially engaged with the actuator 120, the brake pad assembly 140 will be unable to move proximally through the access window 130. However, by manipulating only the spacer 150 radially outward, the actuator 120 may be depressed radially outward, creating clearance for the outward oriented projection or ridge 162, and the brake pad assembly 140 removed as aa unit through the access windows 130. Alternately, the spacer 150 may be pulled out separately from the friction pad 141 and backing plate 142 through the access window 130, whereupon the latter 141, 142 may be subsequently pulled out through the window. The proximal end of the spacer 150 may include a radial aperture which functions as a hand grip to ease manipulation and pulling of the spacer 150 and/or brake pad assembly 140.

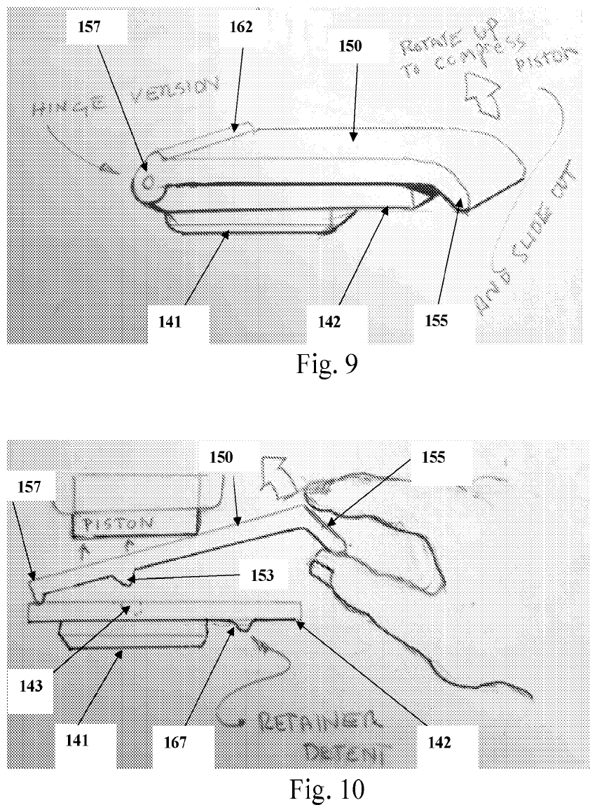

FIG. 9 shows a fourth exemplary brake pad assembly 140. The distal end of a spacer 150 may include a hinge connection 157 to a distal end of the backing plate 142, creating a fulcrum for pivoting motion about the hinge connection 157. The spacer 150 may additionally include an angled or contoured proximal tongue 155 to provide additional leverage or grip for pulling upon and manipulating the assembly 140 for removal as a unit through the access window 130. By manipulating only the spacer 150 radially outward to pivot about the hinge connection 157, the actuator 120 may be depressed radially outward. After restoring the spacer 150 into position against the backing plate 142, the entire assembly may be removed as a unit through the access window 130.

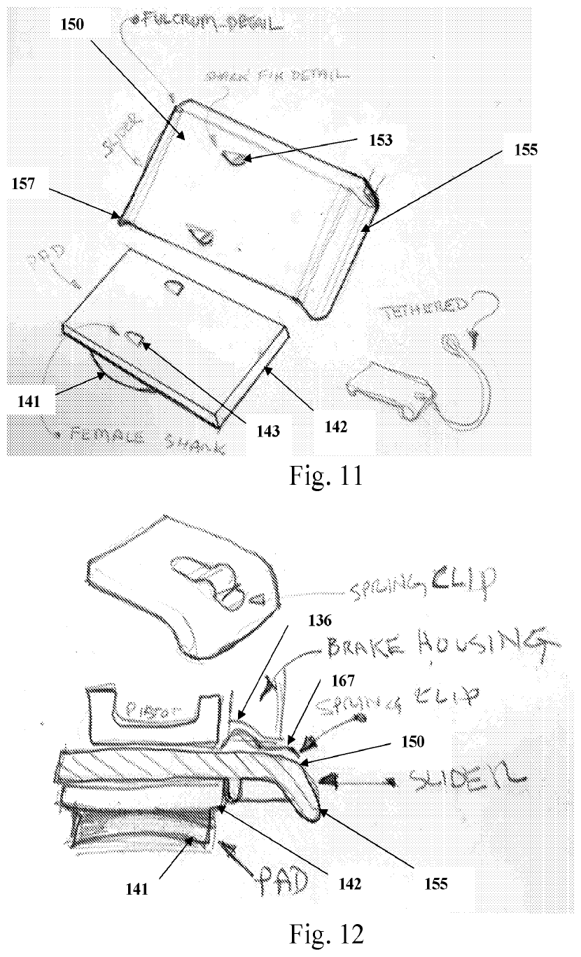

FIGS. 10 and 11 show a fifth exemplary brake pad assembly 140. The distal end of a removable spacer 150 may include a fulcrum element 157 configured to, when assembled, overhang the backing plate 142. By manipulating only the removable spacer 150 radially outward, the actuator 120 may be depressed radially outward, any projection(s) 153 of the spacer 150 separated from any corresponding recess(es) 143 in the backing plate 142, and the removable spacer 150 pulled separately from the friction pad 141 and backing plate 142 along the backing plate 142. After the fulcrum element 157 is pulled past the distal end of the backing plate 142, further manipulation of the removable spacer with the fulcrum element 157 in direct engagement with the backing plate 142 may be used to further depress the actuator 120 radially outward and create additional space to ease removal of the brake pad assembly 140 in a piecewise manner. Projections 153 of the removable spacer 150, which may or may not be included, may also function as a fulcrum for applying force to portions of an actuator 120 proximate to the distal end of the removable spacer 150. FIG. 10 additionally shows a retaining mechanism 160 comprising a projecting detent 167, which may resiliently engage with the bracket 110, such as with a lip formed by or an adjoining depression formed within the access window 130, to retain the brake pad assembly 140 within the bracket. The projecting detent 167 may be affixed to the backing plate 142 and formed from a resilient material such as rubber.

FIG. 12 shows an alternate arrangement of the retaining mechanism in which the projecting detent 167 is affixed to a removable spacer 150. In the illustrated construction, the projecting detent 167 comprises a spring clip, and engagement between the detent/spring clip and an adjoining depression 136 formed within the access window 130 retains the brake pad assembly 140 within the bracket. It will be appreciated that alternate retaining mechanisms such as sliding, rotatable, or detachable clips, flanges or covers, may provided on the axial face 114 of the bracket 110 to engage with or cover the proximal end of the brake pad assembly 140 and retain the assembly within the bracket.

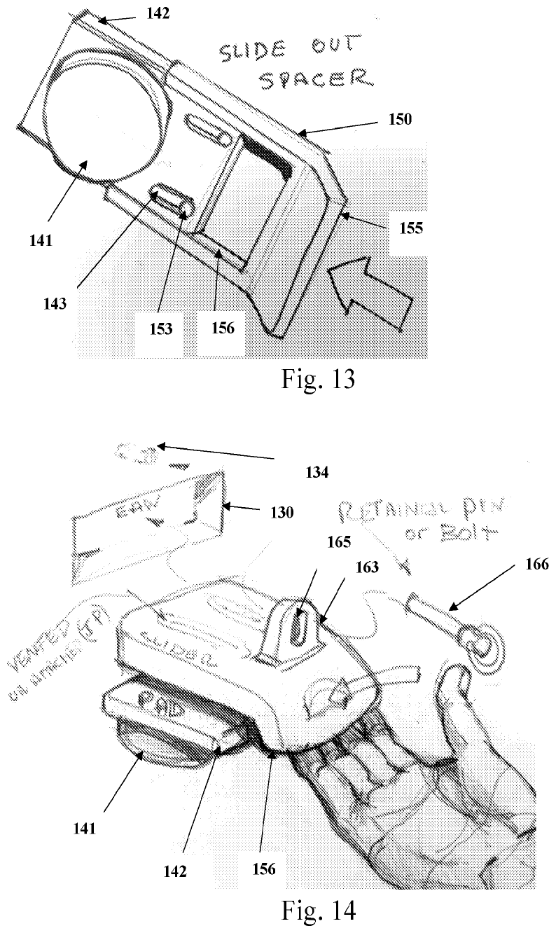

FIGS. 13 and 14 show a sixth exemplary brake pad assembly 140. The spacer 150 may include C-channels 156 which engage the sides of the backing plate 142 to assist in forming an extendable brake pad assembly 140 so that additional leverage may be applied through the proximal end of the spacer 150 to an actuator 120. As shown in FIG. 13, the backing plate 142 may include one or more axially elongated recesses or apertures 143 which may each receive a projection 153 provided in a corresponding location on the removable spacer 150 to interlock the brake pad assembly 140 within a limited range of sliding motion. For removal, spacer 150 may be slid out proximally from the brake pad assembly 140 and manipulated radially outward to depress the actuator 120 radially outward and thus create additional space to ease removal of the brake pad assembly 140.

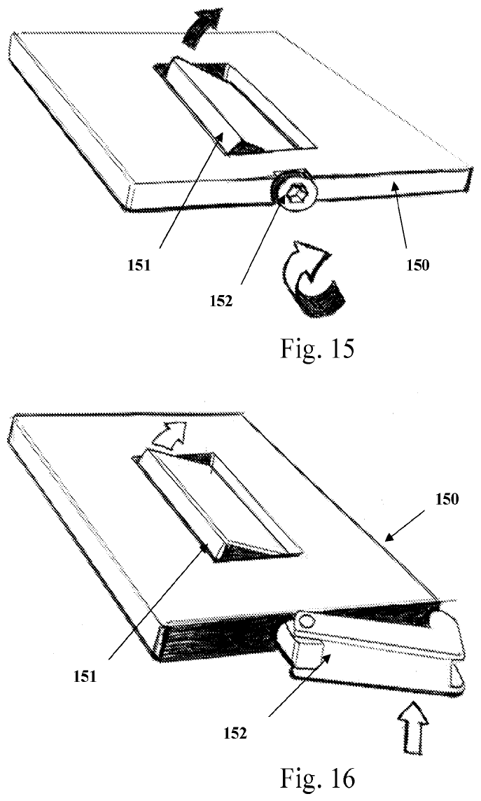

FIGS. 15 and 16 show a spacer mechanism combinable with many of the aforementioned and other exemplary brake pad assemblies 140. A removable spacer 150) may include an interior portion 151 rotatable about an axially oriented axis of rotation and connected to a proximally projecting head or tool end 152 (hereafter, head 152). The head 152 may comprise a hexagonal or other geometrically shaped head, a socket head, a wing-bearing head, or any other form of head configured for manual or tool-assisted manipulation. For manipulation without a separate tool, in the exemplary construction shown in FIG. 16, the head 152 may include a foldable arm, and the arm may be shaped to clip into or about the proximal end of the spacer 150. Rotation of the head 152 rotates the interior portion 151 of the spacer 150 out of alignment with the planar or curved profile of the brake pad assembly 140 to create an increased separation between the backing plate 142 of the assembly and an actuator 120. After the interior portion 151 is restored into general alignment with the profile of the brake pad assembly 140, the removable spacer, and subsequently the backing plate 142 (and associated friction material 141) may be removed in a piecewise manner through the access window 130.

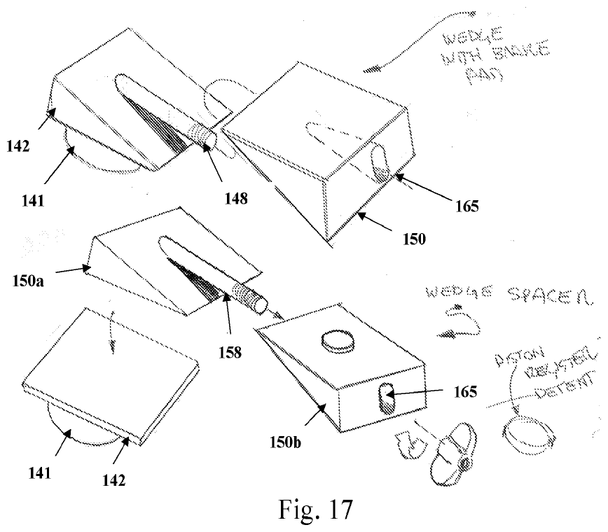

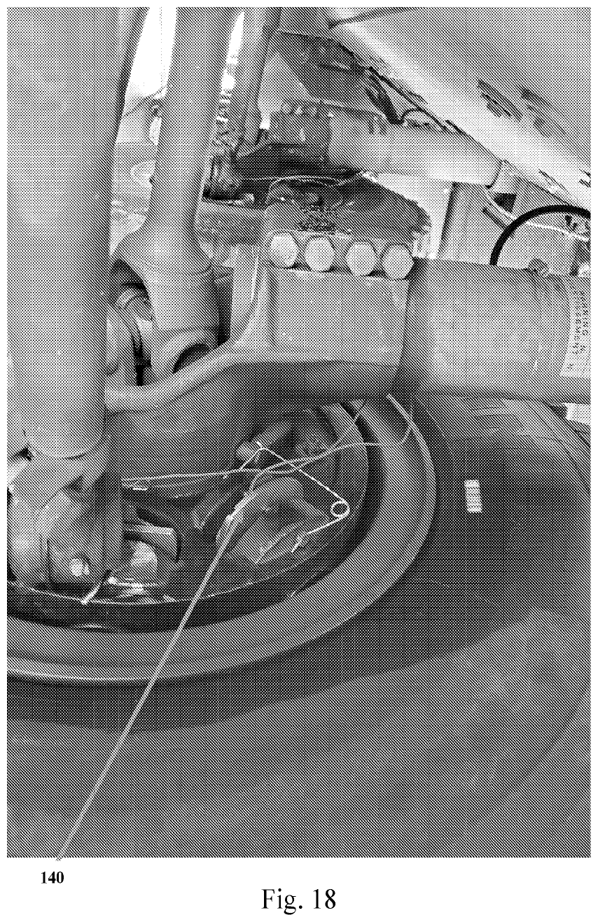

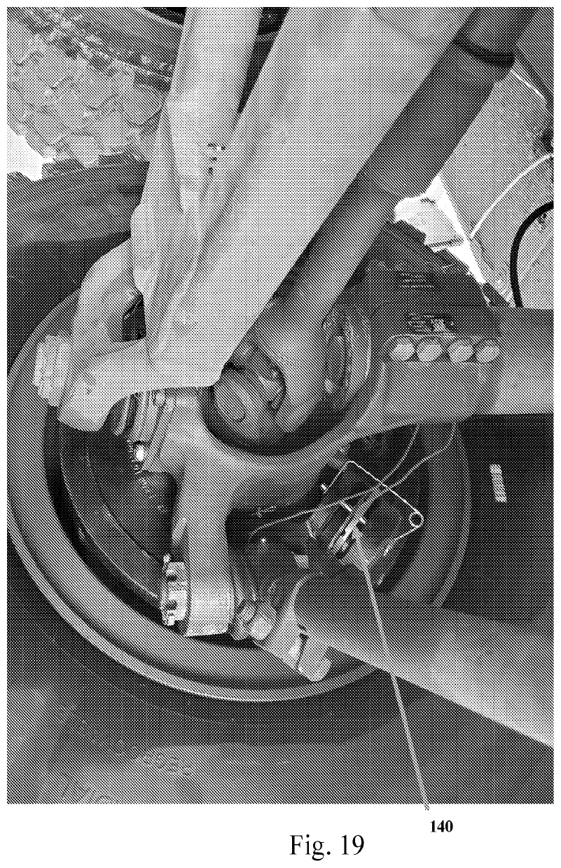

FIG. 17 shows a view of a seventh exemplary brake pad assembly. The backing plate 142 may be shaped as a wedge having a thicker distal end and a thinner proximal end, and the removable spacer 150 may be shaped as a complementary wedge having a thinner distal end and a thicker proximal end. Alternately, as shown in the lower half of the figure, the spacer may comprise both an inward portion 150a, adjoining the backing plate 142, and shaped as a wedge having a thicker distal end and a thinner proximal end, and an outward portion 150b, adjoining the inward portion, and shaped as a complementary wedge having a thinner distal end and a thicker proximal end. The backing plate or inward wedge portion may include a proximally projecting post 148/158 and the spacer or outward wedge portion may include an axially oriented, radially elongated aperture 165. In such a case, the retaining mechanism 160 may include a thumb nut or nut (as shown) engaging threaded proximal end of the post or a retaining pin inserted through the proximal end of the post (not shown). Alternately, rather than providing the post 148/158, the backing plate or inward wedge portion may receive a retaining fastener such as a thumbscrew, screw, bolt, keyed fastener, or other removable fastener. The spacer 150 or outward portion 150b may include an actuator detent 159 to register with the actuator 120 during installation and/or assist in retaining the brake pad assembly 140 within the bracket 110. In general, upon installation the outward wedge may be positioned to completely overlap or proximally overhang the inward wedge. For removal, the outward wedge may be driven axially to completely overlap or distally overhang the inward wedge, depressing the actuator 120. This may be accomplished through operation of a screw mechanism, as in the case of the thumb nut or thumb screw constructions, or applying force against the outward wedge by hand or with a hand tool (such as a mallet), as in the case of the retaining pin or other non-threaded fastener constructions. By pulling upon the interlocked brake pad assembly 140, potentially the entire assembly can be removed as a unit through the access window 130. However, by removing the retaining mechanism, the spacer 150 or outward wedge portion may be separated from the remainder of the assembly, and pulled out separately from the through the access window 130, whereupon the inward wedge portion and other elements may be pulled out through the window.

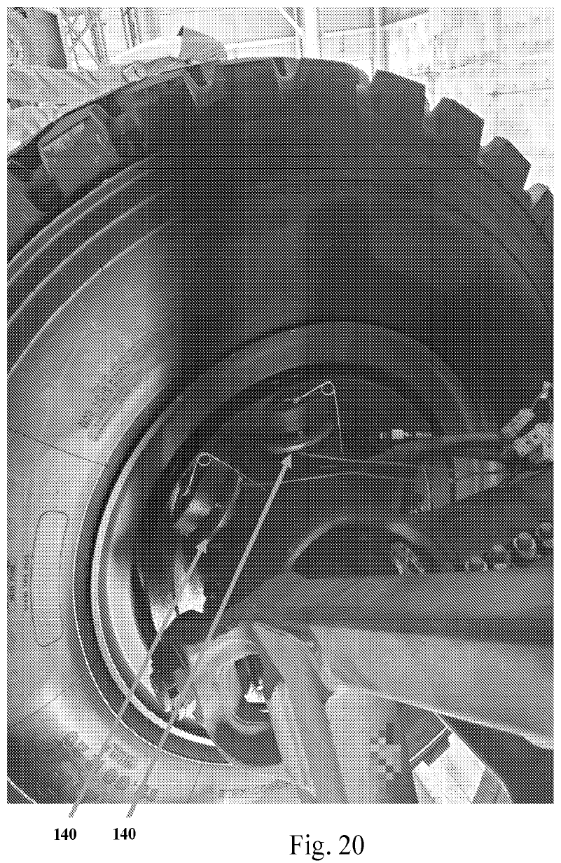

FIGS. 18-20 are photographs of an implementation of the sphere brake assembly of FIGS. 1-4.

It will be appreciated that the individual elements and features of particular exemplary embodiments may be combined with the individual elements and features of other exemplary embodiments in specific implementations of a brake pad assembly not illustrated herein. It will be further appreciated that elements such as the recesses or apertures 143, projections 153, and C-channels 156 may be provided on either the backing plate 142 or the spacer 150 so that the dispositions of these cooperating structures described in particular exemplary embodiments and shown in the figures may be reversed.

What is claimed is:

1. A sphere brake system for a vehicle, the sphere brake system comprising:
a bracket (110) secured to a non-rotating component of the vehicle to at least partially encircle a spherical rotor (90) attached to a rotating member of the vehicle;
a brake pad assembly (140) disposed externally to the spherical rotor (90) and engageable with the spherical rotor (90); and
an actuator (120) engageable with the brake pad assembly (140) to apply a radially inward force, normal to the surface of the spherical rotor (90);
wherein an axial face (114) of the bracket (110) includes an access window (130) located radially in the axial face (114) between the actuator (120) and the spherical rotor (90) and shaped to enable the brake pad assembly (140) to be inserted and removed from the bracket (110) through the axial face (114); and
wherein the brake pad assembly (140) comprises:
a friction pad (141);
a backing plate (142);
a spacer (150); and
a retaining mechanism (160) that is securable to the bracket (110) or axially engageable against the actuator to prevent axial movement relative to the actuator (120).

2. The sphere brake system of claim 1, wherein the axial face (114) includes a pair of radially separated dogs (132) proximate the access window (130), wherein each of the radially separated dogs (132), the backing plate (142), and the spacer (150) include a radial aperture, and wherein a retaining pin (161) is engagable with the radially separated dogs (132), the backing plate (142), and the spacer (150) through the radial apertures.

3. The sphere brake system of claim 1, wherein the spacer (150) includes a beveled distal end (154) for insertion past the actuator (120) and an angled proximal tongue (155) for gripping.

4. The sphere brake system of claim 1, wherein the spacer (150) includes C-channels (156) which engage the sides of the backing plate (142) to allow for separation of the spacer (150) and backing plate (142) along the C-channels.

5. The sphere brake system of claim 4, wherein the backing plate (142) includes one or more axially elongated apertures and the spacer (150) includes one or more projections (153) provided in a corresponding location to interlock the brake pad assembly (140) within a limited range of sliding motion.

6. The sphere brake system of claim 1, wherein the axial face (114) includes a pair of angularly separated dogs (132) proximate the access window (130), wherein each of the radially separated dogs (132) include an angularly oriented aperture, wherein the spacer (150) includes a radial projection (163) with an angularly oriented, radially elongated aperture (164), and wherein a retaining pin (161) is engagable with the angularly separated dogs (132), and the spacer (150) through the respective apertures.

7. The sphere brake system of claim 1, wherein the axial face (114) includes an axially oriented bracket aperture (134), wherein the spacer (150) includes a projection (163) with an axially oriented, radially elongated aperture (164), and wherein a retaining fastener (166) is engagable with the respective apertures.

8. The sphere brake system of claim 1, wherein a distal end of the spacer (150) includes an outward-oriented projection configured for engagement against a distal edge of the actuator (120).

9. The sphere brake system of claim 1, wherein a distal end of the spacer 150 includes a hinge connection to a distal end of the backing plate (142).

10. The sphere brake system of claim 1, wherein a distal end of the spacer (150) includes a fulcrum element (157) configured to overhang the backing plate (142) when assembled with the backing plate.

11. The sphere brake system of claim 1, wherein the access window (130) includes an adjoining depression (136) within the bracket (110), and wherein at least one of the spacer (150) and the backing plate (142) includes a projecting detent (167) engagable with the adjoining depression (136) to retain the brake pad assembly (140) within the bracket (110).

12. The sphere brake system of claim 1, wherein the spacer (150) includes an interior portion (151) rotatable about an axially oriented axis of rotation and connected to a proximally projecting head (152) for manual or tool-assisted manipulation.

13. The sphere brake system of claim 12, wherein the head (152) includes a foldable arm shaped to clip to a proximal end of the spacer 150.

14. The sphere brake system of claim 1, wherein the backing plate (142) is shaped as a wedge having a thicker distal end and a thinner proximal end, the spacer (150) is shaped as a complementary wedge having a thinner distal end and a thicker proximal end, and the spacer (150) includes an axially oriented, radially elongated aperture (165), wherein the retaining mechanism (160) includes a proximally projecting post (148) or a distally projecting fastener secured through the axially oriented, radially elongated aperture (165), and wherein the spacer (150) includes an actuator detent (159) configured to register with the actuator (120).

15. The sphere brake system of claim 1, wherein spacer (150) includes a distal portion (150b), shaped as a wedge having a thicker distal end and a thinner proximal end, and a proximal portion (150a), shaped as a complementary wedge having a thinner distal end and a thicker proximal end, and the proximal portion (150a) includes an axially oriented, radially elongated aperture (165), wherein the retaining mechanism (160) includes a proximally projecting post (148) or a distally projecting fastener secured through the axially oriented, radially elongated aperture (165), and wherein the proximal portion (150a) includes an actuator detent (159) configured to register with the actuator (120).

16. A sphere brake system brake pad assembly, the brake pad assembly (140) comprising:
a friction pad (141) configured to engage a spherical rotor (90) attached to a rotating member of a vehicle;
a backing plate (142);
a spacer (150); and
a retaining mechanism (160) configured to secure the brake pad assembly (140) to a bracket (110) secured to a non-rotating component of the vehicle or to engage against an actuator (120) to prevent lateral movement relative to the actuator (120).

17. The sphere brake system brake pad assembly of claim 16, wherein wherein the spacer (150) includes C-channels (156) which engage the sides of the backing plate (142) to allow for separation of the spacer (150) and backing plate (142) along the C-channels.

18. The sphere brake system brake pad assembly of claim 17, wherein the backing plate (142) includes one or more axially elongated apertures and the spacer (150) includes one or more projections (153) provided in a corresponding location to interlock the brake pad assembly (140) within a limited range of sliding motion.

19. The sphere brake system brake pad assembly of claim 16, wherein a distal end of the spacer 150 includes a hinge connection to a distal end of the backing plate (142).

20. The sphere brake system brake pad assembly of claim 16, wherein the spacer (150) includes an interior portion (151) rotatable about an axially oriented axis of rotation and connected to a proximally projecting head (152) for manual or tool-assisted manipulation.
